(19) United States
(12) Patent Application Publication
(10) Pub. No.: US 2003/0161140 A1
(43) Pub. Date: Aug. 28, 2003

(54) Interchangeable light device

(76) Inventors: Edward Pinto, Fremont, CA (US); Randy Pinto, Fremont, CA (US)

Correspondence Address: MILORD & ASSOCIATES, P.C., 10880 WILSHIRE BOULEVARD, SUITE 2070, LOS ANGELES, CA, 90024, US

(21) Appl. No.: 10/085,749

(22) Filed: Feb. 26, 2002

(51) Int. Cl. F21S 8/00

(52) U.S. Cl. 362/123; 362/183; 362/153; 362/806

(57) ABSTRACT

A lighting device has an interchangeable display element that is illuminated by a light bulb. The display element being maintained on a telescoping body such that the height of the display element is adjustable. The lighting device is operable with a variety of electrical power sources.

### FIELD OF THE INVENTION

The present invention relates to the field of lighting equipment in general, and more particularly, to an outdoor lighting fixture that is transportable and has interchangeable covers and adjustable height.

### BACKGROUND OF THE INVENTION

Various outdoor lighting fixtures are known in the art that illuminate pathways for safety. Numerous light fixtures have been provided along decorative flowerbeds and patio borders or to highlight garden features, and to otherwise light and decorate residential and commercial grounds as art of the overall landscaping. Typically, such fixtures employ a light source, various types of electrical circuitry to provide intermittent illumination and colored film to provide the desired effect or mood. Such devices are generally relatively expensive, not overly attractive and extremely stagnant in their visual effects. Some of the above-referenced designs for lighting fixtures are illustrated in the following patents: Des. 383,867, Des. 341,221, Des. 385,374, Des. 353,014 and Des. 338,080.

The prior art does not address the need for lighting fixtures and equipment that would allow users to interchange the display of a message or the aesthetic functions of the fixture in accordance with the occurrence of a specific event or a holiday season. Therefore, there remains a long standing and continuing need for an advance in the art of light fixtures that is simpler in both design and use, is more effective in allowing the interchangeability of units attached thereto, and is cost efficient in its construction and use.

### SUMMARY OF TIE INVENTION

Accordingly, it is a general object of the present invention to overcome the disadvantages of the prior art.

In particular, it is an object of the present invention to provide a lighting device that is capable of being located at a place having no access to a commercial power source.

It is another object of the present invention to provide a lighting device that is operable on solar energy.

It is another object of the present invention to provide a lighting device that is relatively low in manufacturing costs.

It is yet another object of the present invention to provide a lighting device that automatically turns the device on and off, at dusk and dawn respectively, at appropriate levels of ambient light.

It is yet another object of the present invention to provide a lighting device that has a telescoping arm for controlling the height at which the light will illuminate.

It is a further object of the present invention to provide a lighting device that has an interchangeable display element that is illuminated.

In keeping with the principles of the present invention, a unique lighting device is herein disclosed. According to one advantageous aspect of the present invention, the lighting device has an interchangeable display element that is position over the light bulb and is illuminated thereby. The display element may be easily changed by removable attaching means to communicate different messages or display symbols of a specific holiday season or event. The lighting device also has a telescoping arm to control the height at which the display element is illuminated. In addition, a solar cell may be provided as a power source in order to keep the operation of the lighting device at an inexpensive rate.

Such stated objects and advantages of the invention are only examples and should not be construed as limiting the present invention. These and other objects, features, aspects, and advantages of the invention herein will become more apparent from the following detailed description of the embodiments of the invention when taken in conjunction with the accompanying drawings and the claims that follow.

### BRIEF DESCRIPTION OF THE DRAWINGS:

It is to be understood that the drawings are to be used for the purposes of illustration only and not as a definition of the limits of the invention.

In the drawings, wherein similar reference characters denote similar elements throughout the several views:

FIG. 1 is an elevational side view of the light device in an assembled state illustrating one of many display elements.

FIG. 2 is a cross sectional view of the light device taken along line 2-2 of FIG. 1.

FIG. 3 is an elevational side view of one preferred embodiment of the display element.

FIG. 4 is an elevational side view of an alternate preferred embodiment of the light device without the display element attached.

### DETAILED DESCRIPTION OF THE INVENTION:

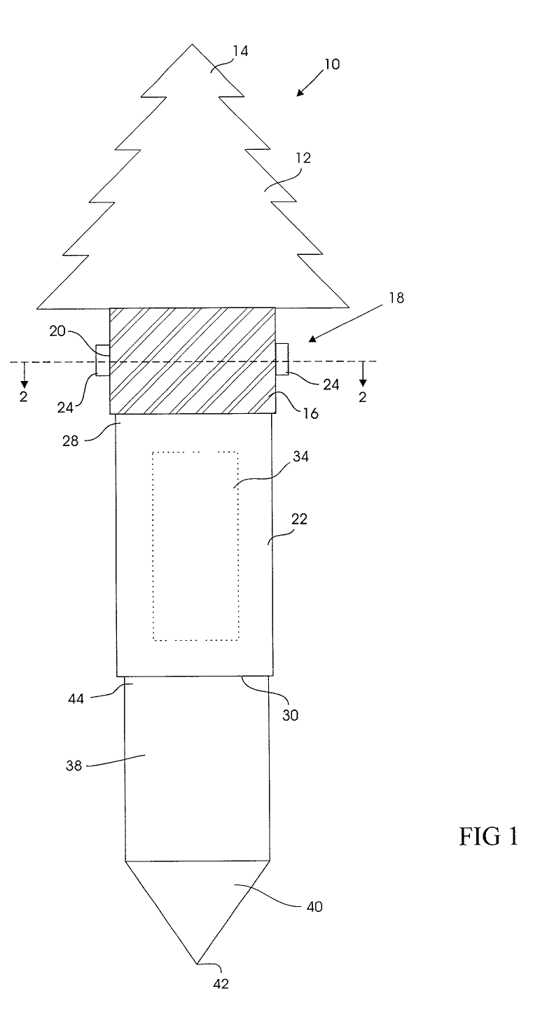

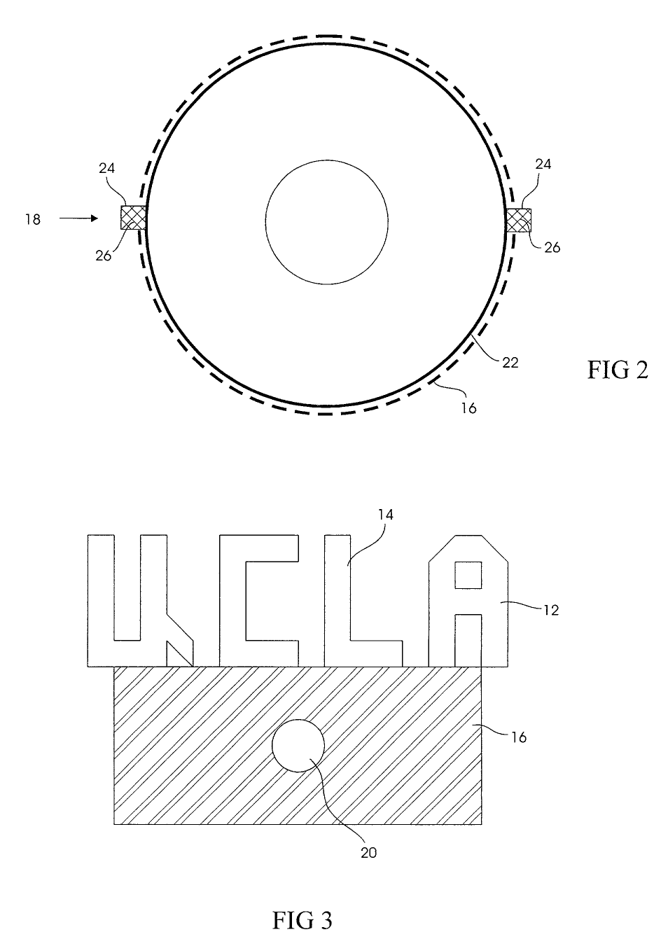

Referring to FIG. 1 and FIG. 2, therein is illustrated an interchangeable light device 10 having a display element 12. Display element 12 has a top region 14 connected to a bottom region 16. Top region 14 may be adapted into any shape and size as required and also adapted to relay a written message, symbols of a specific holiday season, symbols of a specific sporting event, or a celebration of a specific occasion. For purposes of illustration, but not limitation, display element 12 may be manufactured of a translucent polymeric compound such as, but not limited to, polystyrene or polyethylene. Specific colors may also be applied as desired to the compound comprising display element 12 by methods known in the art to effectuate the transmittance of the colors when in operation.

Now also referring to FIG. 3, bottom region 16 of display element 12 has a removable attaching means 18 connecting to at least an aperture 20 thereof. Several alternate attaching means 18 that are known in the art may be used to removably attach display element 12 to a support element 22. However, for purposes of illustration, but not limitation, a resilient snap-on design is herein illustrated. At least two protruding members 24 extend from opposing sides of support element 22 which is substantially tubular in shape. Protruding members 24 move in a horizontal plane and are movably kept in place by a resilient member 26 that are maintained in each of the protruding members 24. Resilient member 26 may be made of any known resilient devices that are known in the art such as, but not limited to, a spring. As such, protruding members 24 are maintained in an extended position at rest such that they extend through aperture 20 of bottom region 16 and maintain display element 12 on support element 22.

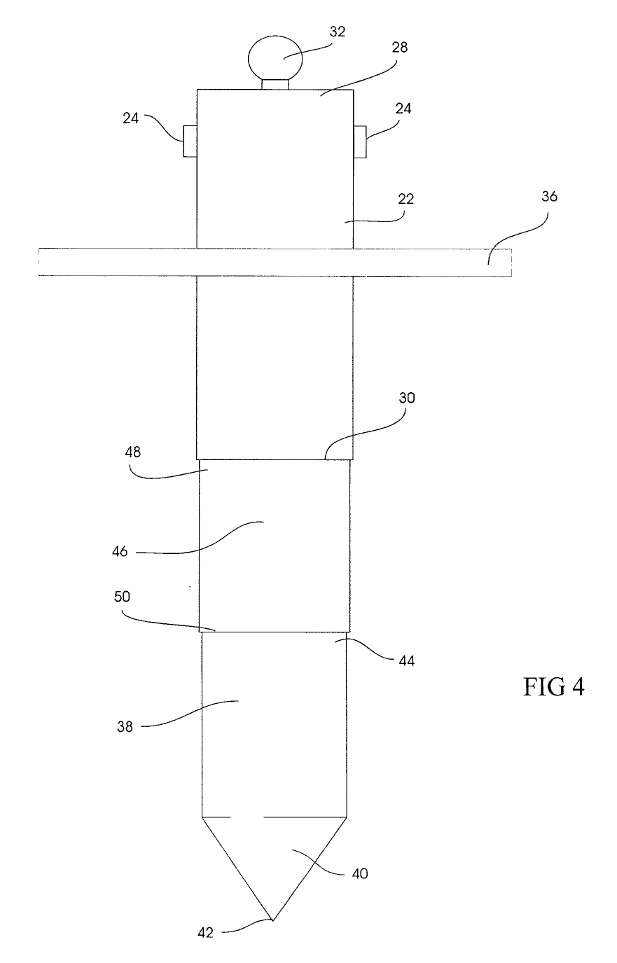

Now also referring to FIG. 4, support element 22 is substantially tubular in shape and has a top end 28 and a bottom end 30 that is distal thereto. Although a tubular shape is illustrated for both support element 22 and bottom region 16 of display element 12, it is to be understood that a variety of alternate shapes are also possible without departing from the essence of the invention. As such, support element 22 has a sufficiently shorter diameter than the diameter of bottom region 16 to allow bottom region 16 to slideably receive top end 28 of support element 22 therein. In order to remove display element 12, protruding members 24 are depressed into apertures 20 and display element 12 is slid off top end 28 of support element 22.

Top end 28 receives a light bulb 32 in any manner that is known in the art. In addition, any low wattage lamp that is commonly known in the art may be used. For example, a fluorescent lamp, a low-pressure sodium lamp, a low pressure mercury lamp, an incandescent lamp or any other known lamp can be employed. However, for purposes of illustration, but not limitation, a low wattage fluorescent lamp, of approximately 4 W, may be used as light bulb 32 in one preferred embodiment hereof. A power source 34 is stored within support element 22 and communicates with light bulb 32 in a manner that is known in the art. Power source 34 may be any suitable low-voltage electrical power that is known in the art, and in one preferred embodiment, as illustrated in FIG. 4, power source 34 is linked with a solar cell 36. Power source 34 may be a rechargeable battery that is charged with electrical energy from the solar cell 36 via a diode, which is adapted to prevent a reverse electrical flow. An inverter may be provided, if necessary, to convert a d.c. current from the power source 34 into a high voltage a.c. current for lighting the light bulb 32. In addition, logical operation circuits, which are known in the art, may be provided to distinguish between daytime and nighttime and to either turn light bulb 32 on or off. Furthermore, power source 34 may be provided with additional circuits that are known in the art to prevent the battery from being over discharged and avoiding the expenses related to the replacement thereof.

An affixing element 38 is adapted to be connected to a floor via an affixing end 40. Although affixing end 40 is illustrated herein as having a sharp end 42 for staking into the soil, it is to be understood that alternate affixing ends 40 which are known in the art for attachment to the ground may be substituted therefor. Affixing element 38 has a top boundary 44 that is distal to the affixing end 40. Referring specifically to FIG. 1, affixing element 38 telescopes from the bottom end 30 of support element 22 in any manner that is known in the art. However, in one preferred embodiment, the same technology used in telescoping antennas that are commonly used on automobiles may be employed such that when affixing element 38 is fully extended, top boundary 44 engages bottom end 30 of support element 22 in a secure manner.

Now also referring to FIG. 4, at least an extending element 46 may be inserted between bottom end 30 of support element 22 and top boundary 44 of affixing element 38. Additional extending elements 46 may be inserted as desired in order to allow the user to determine the height at which the display element 12 will be presented. Extending element 46 has an upper end 48 that is distal to a lower end 50. When fully extended, upper end 48 will engage bottom end 30 of support element 22 and lower end 50 of extending element 46 will engage top boundary 44 of affixing element 38 in a secure, yet collapsible, manner.

While the above description contains many specificities, these should not be construced as limitations on the scope of the invention, but rather as exemplifications of preferred embodiments thereof. Many other variations are possible without departing from the essential spirit of this invention. Accordingly, the scope of the invention should be determined not by the embodiments illustrated, but by the appended claims and their legal equivalents.

What is claimed is:

1. A lighting device, comprising:
a display element that is removably attached to a support element by an attaching means;
a light bulb being positioned on said support element such that said light bulb illuminates said display element;
an electrical power source stored within said support element; and
said support element being removably affixed to a surface.

2. The device of claim 1, wherein said display element has a top region that is aesthetically designed and a bottom region that attaches to a top end of said support element via an attaching means.

3. The device of claim 2, wherein said bottom region of said display element is substantially annular and accommodates the top end of the support element in a frictional manner.

4. The device of claim 2, wherein said bottom region of said display element has a substantially annular wall;
said attaching means being defined by at least an aperture defined through said wall and able to receive a retractable protruding member extending from said support element;
whereby, the protruding member extends through said aperture by force from a resilient member in a resting stage and prevents removal of said display element.

5. The device of claim 2, wherein said light bulb is positioned on said top end of said support element;
a bottom end of said support element being distal to said top end;
said support element being tubular in nature such that said bottom end has an opening for frictionally receiving an affixing element therein.

6. The device of claim 5, wherein the affixing element is telescopic in nature, whereby said display element may be presented at differing heights.

7. The device of claim 2, wherein said light bulb is positioned on said top end of said support element;
a bottom end of said support element being distal to said top end;
said support element being tubular in nature such that said bottom end has an opening for frictionally receiving an upper end of an extending element therein;
said extending element having an lower end that is distal to said upper end;
said extending element being tubular in nature such that said lower end receives a top boundary of an affixing element therein in a frictional manner;
an affixing end of said affixing element being distal to said top boundary and removably attaching to a surface.

8. The device of claim 7, wherein the extending element and said affixing element are telescopic in nature, whereby said display element may be presented at differing heights.

9. The device of claim 2, wherein said power source is a rechargeable battery that is recharged by a solar cell that is affixed to an outer wall of said support element and is in communication with said rechargeable battery therethrough.

10. The device of claim 8, wherein said power source is a rechargeable battery that is recharged by a solar cell that is affixed to an outer wall of said support element and is in communication with said rechargeable battery therethrough.

11. An adaptable lighting device, comprising:
a display element having a top region of an aesthetic design and a bottom region having a hole therein;
a support element having a top end and a bottom end and said top end being insertable into said hole of said bottom region of said display element in a frictional manner to removably engage said bottom region via an attaching means;
a light bulb being positioned on said top end of said support element such that said light bulb illuminates said display element;
an electrical power source stored within said support element; and
said support element being removably affixed to a surface.

12. The device of claim 11, wherein said bottom region of said display element has a substantially annular wall;
said attaching means being defined by at least an aperture defined through said wall and able to receive a retractable protruding member extending from said support element;
whereby, the protruding member extends through said aperture by a force exerted by a resilient member in a resting stage and prevents removal of said display element.

13. The device of claim 11, wherein said light bulb is positioned on said top end of said support element;
said support element being tubular in nature such that said bottom end has an opening for frictionally receiving an affixing element therein;
said affixing element being telescopic in nature, whereby said display element may be presented at differing heights.

14. The device of claim 11, wherein said light bulb is positioned on said top end of said support element;
said support element being tubular in nature such that said bottom end has an opening for frictionally receiving an upper end of an extending element therein;
said extending element have a lower end that is distal to said upper end;
said extending element being tubular in nature such that said lower end receives a top boundary of an affixing element therein in a frictional manner;
an affixing end of said affixing element being distal to said top boundary and removably attaching to a surface; and
said extending element and said affixing element are telescopic in nature, whereby said display element may be presented at differing heights.

15. The device of claim 14, wherein said power source is a rechargeable battery that is recharged by a solar cell that is affixed to an outer wall of said support element and is in communication with said rechargeable battery therethrough.

16. The device of claim 14, wherein said display element is manufactured from a translucent polymeric compound.

17. The device of claim 16, wherein said translucent polymeric compound is selected from a group consisting of polystyrene and polyethlylene.

18. The device of claim 11, wherein said power source is obtained from commercially available electricity wired thereto.

19. The device of claim 14, wherein said affixing element, said extending element, and said support element are manufactured to be impenetrable to liquids.

20. A portable lighting device, comprising:
a display element having a top region of an aesthetic design and a bottom region having defined by an annular wall such that a hole is defined therein;
a support element having a top end and a bottom end and said top end being insertable into said hole of said bottom region of said display element in a frictional manner to removably engage said bottom region via an attaching means;
said attaching means being defined by at least an aperture defined through said wall and able to receive a retractable protruding member extending from said support element and, whereby, the protruding member extends through said aperture by a force exerted by a resilient member in a resting stage and prevents removal of said display element
a light bulb being positioned on said top end of said support element such that said light bulb illuminates said display element;
an electrical power source stored within said support element;
said support element being tubular in nature such that said bottom end has an opening for frictionally receiving an upper end of an extending element therein;
said extending element having a lower end that is distal to said upper end;
said extending element being tubular in nature such that said lower end receives a top boundary of an affixing element therein in a frictional manner;
an affixing end of said affixing element being distal to said top boundary and removably attaching to a surface; and
said extending element and said affixing element are telescopic in nature, whereby said display element may be presented at differing heights.
